(19) United States
(12) Patent Application Publication
(10) Pub. No.: US 2002/0138510 A1
(43) Pub. Date: Sep. 26, 2002

(54) Method, system, and program for tracking quality assurance processes

(75) Inventor: Rick S. Tan, Union City, CA (US)

Correspondence Address: KONRAD RAYNES VICTOR & MANN, LLP, 315 SOUTH BEVERLY DRIVE, SUITE 210, BEVERLY HILLS, CA, 90212, US

(73) Assignee: Sun Microsystems, Inc.

(21) Appl. No.: 09/768,326

(22) Filed: Jan. 24, 2001

(51) Int. Cl. G06F 17/21

(52) U.S. Cl. 707/501.1; 707/530

(57) ABSTRACT

Disclosed is a system, method, and program for providing a QA tool to organize all the QA processes and report the QA results in an efficient and organized manner. A main page and hyperlinks are automatically generated from a database of test cases and tested devices to connect the all of the QA documentation, test results, and test logs for a specific device, wherein the main page and subsequent linked pages are viewable by a web browser.

### BACKGROUND OF THE INVENTION

1. Field of the Invention

The present invention relates to a method, system, and program for tracking quality assurance processes.

2. Description of the Related Art

Quality Assurance (“QA”) procedures are in common practice throughout many industries. Companies utilize quality assurance procedures for the products to maintain product quality, discover errors in the firmware, hardware, or software, and to set basic standards of product review. Quality assurance procedures are often highly tailored to the products/services of the company where, often times, each separate component of a product/service has a unique QA protocol in place. Typically, these procedures have extensive documentation associated with any QA testing.

QA documentation usually has three levels associated with any QA procedure. The first level of documentation is the Test Plan. The Test Plan typically entails a high-level overview of the product, goals of the testing, and expected tests to perform. The next level of documentation is the Test Case Specification, which provides additional details on the nature of the tests, such as the specific components to test. For instance, in testing a storage system, the Test Case Specification would indicate to test components such as the Redundant Array of Independent Disk (RAID) arrays, multipathing, software support, interoperability, etc. The test case specification may identify the components to test. Often, more than one Test Case Specification will be described within an overall Test Plan for a product.

The final level of documentation is the Test Procedures, which describes each QA test on a step-by-step basis in exacting detail to describe how to perform each QA test and how to record the results. There may be plurality of Test Procedures associated with any single Test Case Specification indicating specific testing operations for a component. Often times, the QA procedures for different products and the product components requires substantial documentation. Currently, QA testing procedures are maintained in books or manuals indexed through a table of contents or other library focused cataloging technique. The sheer volume and complexity of QA procedures make referencing relevant documentation difficult. Only after a time consuming library search, can relevant documentation be located for any specific QA test procedure. This problem is enhanced if the QA test is outside the usual specialty of the QA test administrator/engineer.

In addition, QA test results may include notations and comments from a QA test engineer that are difficult to decipher without supporting documentation. In fact, QA engineers are often requested to spend time explaining the QA test results to others. This effort requires that the QA engineer devote substantial time to explaining to the interested parties the QA results. This problem is further exasperated because QA engineers do not have a uniform method of presenting and organizing the test results.

For these reasons, there is a need in the art for improved techniques for managing QA documentation and test results.

### SUMMARY OF THE PREFERRED EMBODIMENTS

To overcome the limitations in the prior art described above, preferred embodiments disclose a system, method and program for providing a QA tool to organize all the QA processes and report the QA results in an efficient and organized manner. The method, system and program are implemented by displaying a main page including sections for different device components, displaying hyperlinks from the main page to overview pages providing an overview of diagnostic test operations to perform on the device, and for each component listed on the main page, displaying a hyperlink in the main page to a component test page providing details on diagnostic tests to perform on the component listed on the main page. In further embodiments, additional hyperlinks for each component listed on the main page provide access to test result data generated when performing the diagnostic test described in the component test page on the component listed on the main page.

BRIEF DESCRIPTION OF THE DRAWINGS

Referring now to the drawings in which like reference numbers represents corresponding parts throughout:

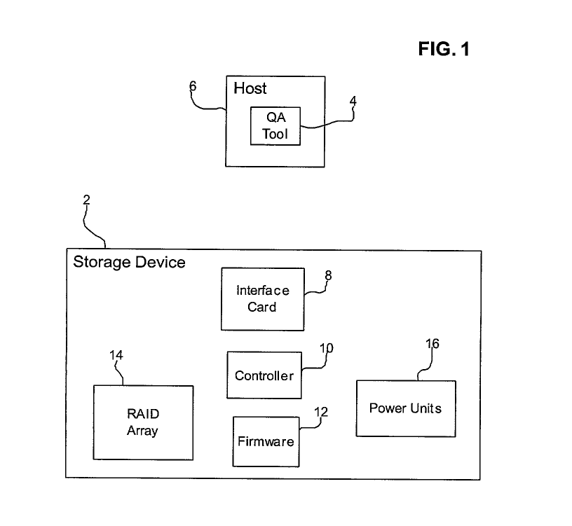

FIG. 1 illustrates a computing environment implemented for testing a storage device using a quality assurance (QA) tool;

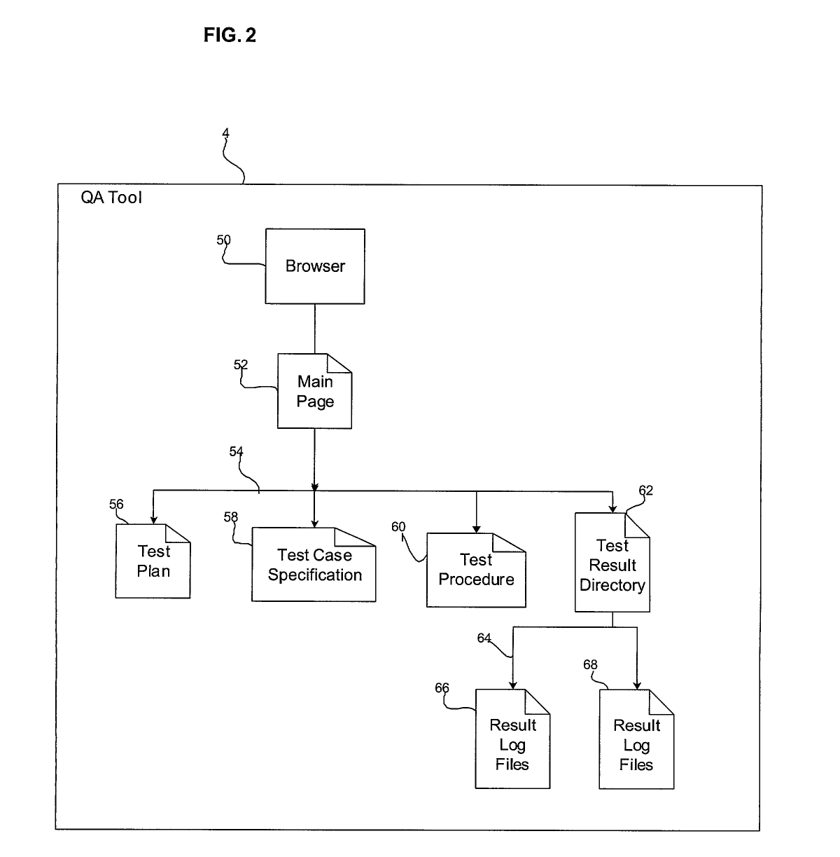

FIG. 2 illustrates the components of the QA tool implemented to perform the present invention;

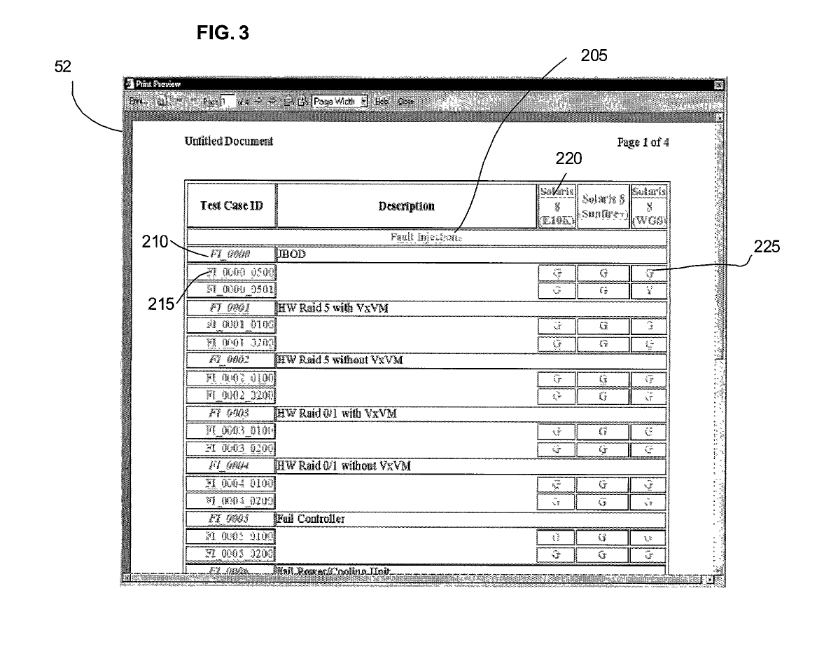

FIGS. 3-6 illustrate examples of HTML pages that are implemented as part of the graphical user interface;

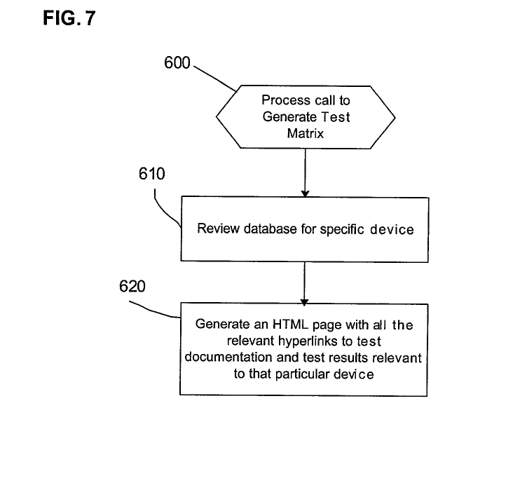

FIG. 7 illustrates the logic of a script program implemented to generate the main HTML page; and

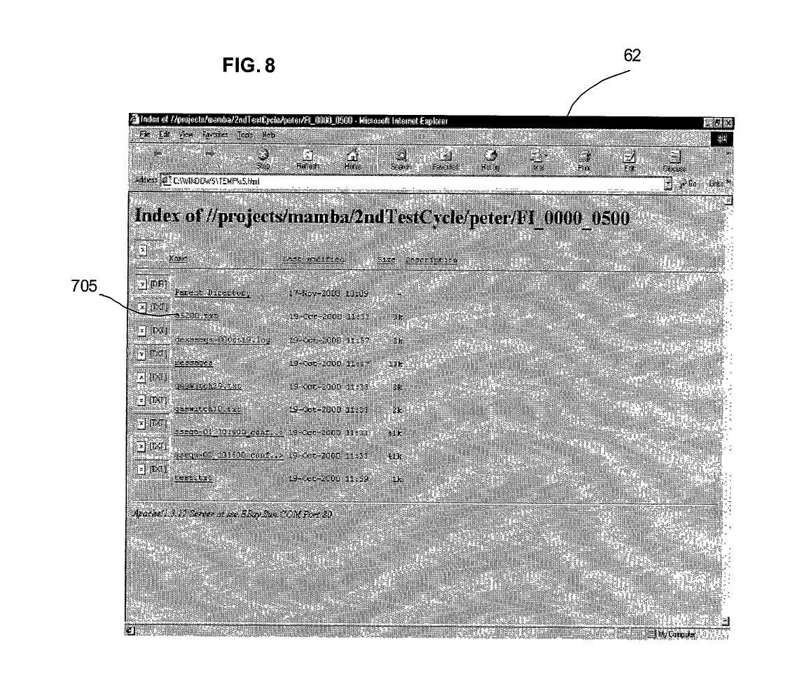

FIG. 8 illustrates a further example of an HTML page implemented as part of the graphical user interface.

### DETAILED DESCRIPTION OF THE PREFERRED EMBODIMENTS

The preferred embodiments are directed to a method and system for tracking quality assurance (QA) processes over a network. By interlinking HTML pages containing relevant QA process information and building a central record of test results via a secured network, each step of the QA process can be monitored and referenced to its respective documentation via any computing device having a web browser program.

In the following description, reference is made to the accompanying drawings which form a part hereof, and which illustrate several embodiments of the present invention. It is understood that other embodiments may be utilized and structural and operational changes may be made without departing from the scope of the present invention.

Computing Environment

FIG. 1 illustrates a computing environment for testing a storage device 2 using a quality assurance (QA) tool 4 installed on a host system 6. The tested storage device 2 includes an interface card 8 which provides for communication over a network, such as an Ethernet card, Fibre Channel protocol interface card, etc., a controller 8, firmware 10 executed by the controller 8, a RAID array 12, and power units 14, such as power and cooling units, batteries, etc. Each of the above components may be tested according to QA procedures described in test related documentation, such as a test plan, test case specification, and test procedure file discussed above. Additional components of the storage device 2 may also be tested, such as the drives, data transfer paths, etc. Although in FIG. 1, the host 6 is implemented on a stand alone basis from the tested storage device 2, alternative embodiments can have the host system tied directly to the tested storage device 2. The host 6 may then communicate with the storage device 2 using any communication interface known in the art e.g., Ethernet, Fibre Channel, serial interface, etc.

QA Tool

The QA tool 4 integrates the documentation referenced to implement QA procedures through linked directories of files that may be navigated using an Internet browser, e.g., Microsoft Internet Explore, Netscape Communicator, etc., to provide the user access to Quality Assurance documentation. FIG. 2 illustrates the components of the QA tool 4, including a browser program 50, such as a web based browser or other viewing program known in the art, a main page 52 that provides an index to the QA documentation and test results, including hyperlinks 54 to the actual QA documentation and test result information. The terms hypertext link and hyperlinks are used interchangeably herein to refer to an element in an electronic document that links to another place in the same document or to an entirely different document. Typically, a user clicks on the hyperlink to follow the link. In the described implementations, the main page 52 provides hyperlinks 54 to one or more text plan pages 56 which provide high level, general descriptive information on the background, features to be tested, types of test being performed. In addition, the main page 52 provides hyperlinks 54 to one or more component test pages. In the current implementation, component test pages are divided into (1) test case specification pages 58 that provides additional detail as to the type of tests performed (e.g. tests on installation and bootability, load and stress tests, data reliability/integrity, fault injection tests, etc.) and components to test (e.g., the RAID array 14, controller 10, firmware, etc.), and (2) test procedure pages 60 that provide detailed step-by-step explanations on the test to perform for a tested component. However, those skilled in the art will recognize that the information described in the case specification pages 58 and test procedure pages 60 can be combined into a single component test page or distributed across additional component test pages. Furthermore, the hyperlinks 54 provide links to one or more test result directory 62 pages that provide, for each tested component, a directory of hyperlinks 64 to result log files 66, 68 providing test result data for the tested component.

FIGS. 3-6 and 8 illustrate examples of HTML page implementations of pages 52, 56, 58, 60, 62, and 64 accessible through browser 50. In certain implementations, the HTML pages are identified with a Uniform Resource Locator or “URL” address. In this way, users may access the various pages 52, 56, 58, 60, 62, 66, and 68 from over an internal network, e.g., LAN or the Internet. The main page 52 may be returned from a server providing information on the main page, and the URLs of the pages 56, 58, 60, 62, 66 and 68 may be stored on the server including the main page 52 or other storage locations in a network environment.

FIG. 3 illustrates an example of the main page 52, providing a QA test matrix listing all tests being performed on the storage device 2 along with current test results and related hyperlinks providing all the relevant QA documentation associated with each particular test. The main page 52 lists tests for a storage device including the Sun Microsystem Solaris 8 operating system.** In the example of FIG. 3, the main page 52 provides hyperlinks to information on failure testing procedures for the JBOD (which means Just a Bunch of Disks), RAID devices, controller and cooling unit. The main page 52 could also provide QA test documentation for failure tests of a Gigabyte Interface Converter Modules (GBIC) in the interface card 8, battery, interface card 8, and any connected host or switch. The main page 52 could also provide hyperlinks to test documentation for testing the firmware 12, the availability of data paths from the hosts to the storage device 2, load and stress tests, etc. **NETSCAPE is a registered trademark of the Netscape Communications Corporation; WINDOWS and MICROSOFT are registered trademarks of Microsoft Corporation; SOLARIS is a trademark of Sun Microsystems, Inc.

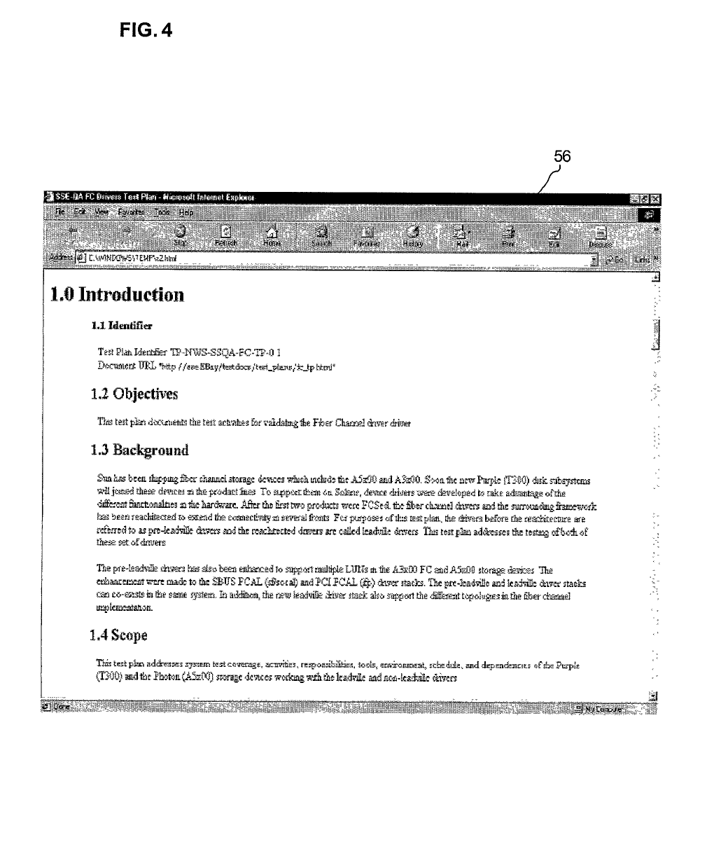

In the center column, hyperlinks with the names of the specific Test Plans to perform on the storage device 2 are listed. In the example of FIG. 3, the Fault Injection Test Plan may be one of many QA test plans to perform on the product 2. The Test Plan link 205 is a hyperlink to the Test Plan page 56 associated with the specific QA procedure. In the example of FIG. 3, the Test Plan link 205 links to the Fault Injection Test Plan 56 shown in FIG. 4. As mentioned above, the Test Plan page 56 describes the high level description of the QA procedure listing the test items, features to be tested, general approach, pass/fail criteria, responsibilities of the various parties, schedule of tests, etc. In the example of FIG. 4, the Test Plan page 56 describes the various fault injections introduced into the storage device 2 to determine how the system responds. However, other test plans such as Firmware tests, High Availability tests, Load and Stress test, etc. are part of the overall testing strategy of the storage device 2, and are hyperlinked from the same HTML page 52 as the Fault Injections Test link 205.

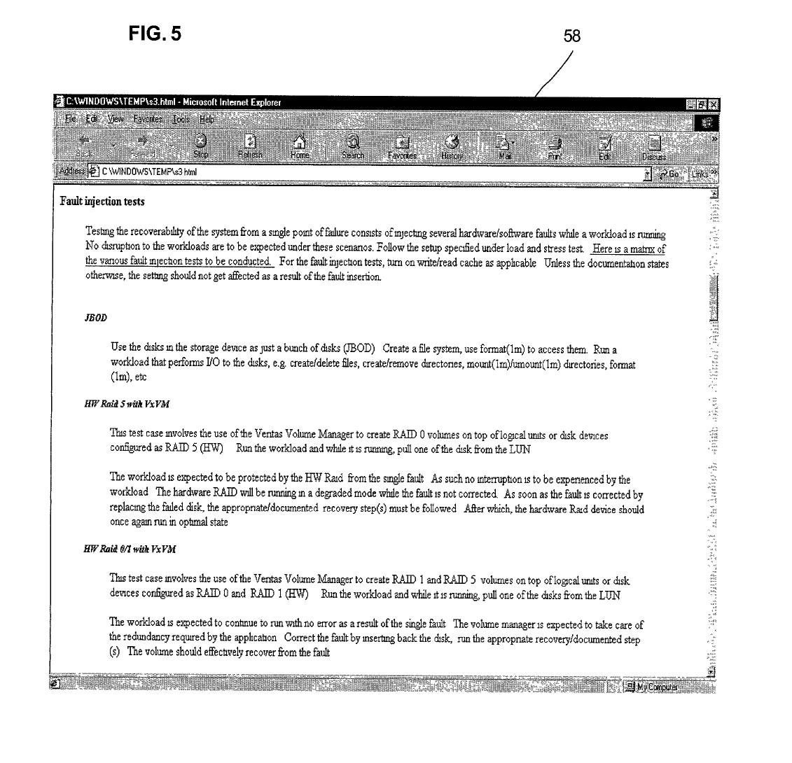

In reference to FIG. 3, along a first column labeled Test Case ID, additional hyperlinks are located that are associated with each QA procedure within a Test Plan. Two class of hyperlinks exist in the column, one for the Test Case Specification and the other for Test Procedures. The Test Case Specification link 210 (shown in Bold and Italics) provides a hyperlink to Test Case Specification page providing additional detail about the test procedure to perform under the Test Case 56 for the specific storage device 2 component. In the example of FIG. 3, Test Case Specification links are shown for the JBOD, RAID devices, controller and cooling unit. Test Case Specification Link 210 provides the link to the Test Case Specification page for the JBOD component. FIG. 5 provides an example of an implementation of the Test Case Specification page 58. For example, the FI_{—}0000 link 210 provides a link to the section in the Test Case Specification page 58 including information on the test to perform for the JBOD component. Similarly, the FI_{—}0001 text provides a hyperlink to a location in the Test Case Specification page 58 relating to the HW Raid 5 with V×VM component, and so on.

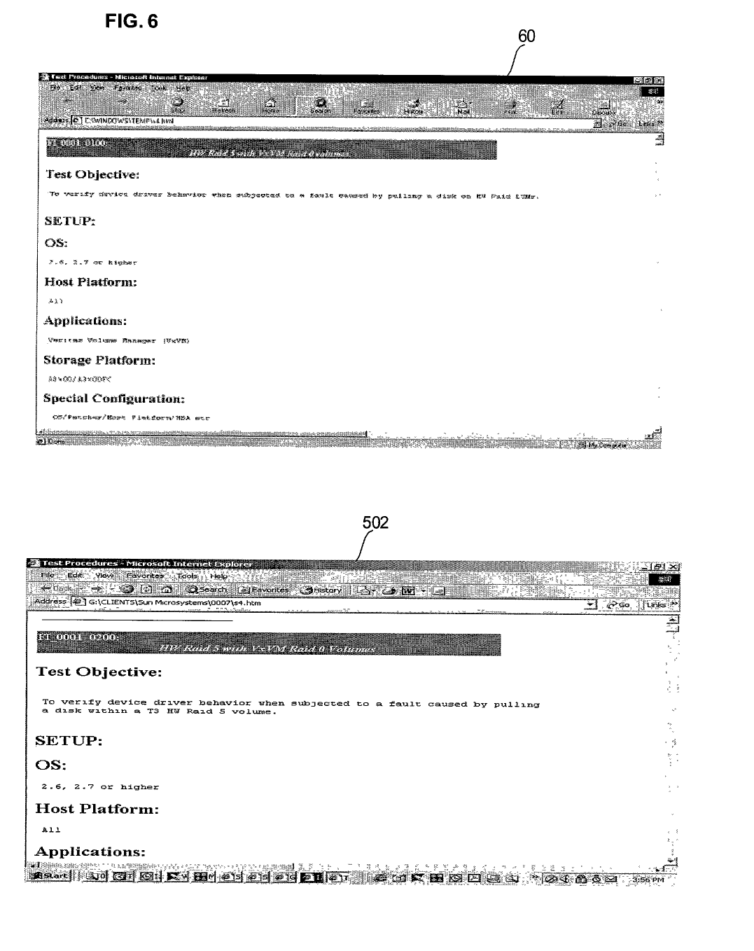

FIG. 6 provides an example of a Test Procedure page 60 providing detailed information on the test procedures to perform. The test procedure link 215 (shown with a 10 character ID in FIG. 3) provides a hyperlink to Test Procedure page providing the step-by-step procedures to perform for a particular QA test. For example, the FI_{—}0001_{—}0100 link 215 pinpoints the section in the Test Procedure page 60 providing information on the HW Raid 5 with V×VM device as seen in FIG. 6. Similarly, window 502 in FIG. 6 illustrates the test procedure information upon selection of the hyperlink behind the FI_{—}0001_{—}0200 text, which provides information on the same HW Raid 5 with V×VM device, and so on. In this way, different tests for a single device, e.g., the HW RAID 4 with V×VM device, may be provided through separate hyperlinks, FI_{—}0001_{—0100} and FI_{—}0001_{—}0200. The use of hyperlinks next to the QA test results provides quick reference and efficient access to the supporting QA documentation as needed. This will provide substantial assistance to allow a testing engineer to access from a main page 52 all the information needed to perform tests on the storage device 2 and review the results of the diagnostic testing.

FIG. 7 illustrates the logic of a script program to generate the main page 52, in a format such as HTML, Extensible Markup Language (XML), etc. In certain implementations, the user may enter information into a database on components to be tested. A database record would be created for each component to test. Each component record would include fields including information on the documentation, such as the hyperlinks, for the test plan 56, test case specification 58, test procedure 60, and test result directory 62 pages for the component. The QA administrator may enter such information into the database. The database may maintain information for multiple storage devices 2 to test. A script program begins at block 600 to generate a main page 52 providing a matrix of the components based on the database component records for the storage device 2 to test. The script program searches (at block 610) for the particular device in the database and its associated test documentation. At block 620, the script program generates an HTML main page 52 with all the relevant hyperlinks to test documentation and test results relevant to that particular device.

Referring back to FIG. 3, the right hand side of the page 52 includes alphanumeric color codes 225 to indicate the test results of the various QA tests performed on a specific component. In certain implementations, the following legend is used to associate descriptive information on the test results with the color coding.

| | |
|---|---|
| W (white) | Testing not started |
| G (green) | Test passed without problem |
| Y (yellow) | Minor problem(s)/bug(s) discovered, not test |
| | stopper |
| R (red) | Major problem(s)/bug(s) discovered, test |
| | stopper |
| C (cyan) | Testing is being done outside of SSE/QA |
| n/a | Not applicable |
| n/p | Not planned for |

In FIG. 3, the color codes 225 are listed under three separate columns to provide information on three different hardware configurations used for the testing. For example in FIG. 3, three hardware configurations are used: Solaris 8 (E10K), Solaris 8 (Sunfire+), and Solaris 8 (WGS). Each column heading link 220 provides additional hyper text links to a diagram illustrating the actual hardware configuration used for the testing (not shown).

In addition, each color code 225 itself is a hyperlink The color code 225 is linked with a Test Result Directory page 62. FIG. 8 provides an example of a Test Result Directory page 62. The Directory page 62 provides hyperlinks to locations where the diagnostic test result log files 66 and 68 (FIG. 2) are located. Upon accessing one of the hyperlinks in the test result directory page 62, the content of the result log file 66 or 68 addressed by the hyperlink would be displayed in the browser 50. The result log files 66 and 68 may maintain information of all the steps of the QA diagnostic tests, such as the level of firmware used, the number disks used, what workload was executed, what options were used in running the workload, who the test taker was, etc. In certain implementations, the Test Result Directory page 62 may be generated automatically from a script program that determines the result log files 66, 68 and locations thereof including the diagnostic test results and provides links to these result log files 66, 68 in the test result directory 62.

Following are some alternative implementations.

The preferred embodiments may be implemented as a method, apparatus or program using standard programming and/or engineering techniques to produce software, firmware, hardware, or any combination thereof. The term “article of manufacture” (or alternatively, “computer program product”) as used herein is intended to encompass one or more computer programs and data files accessible from one or more computer-readable devices, firmware, programmable logic, memory devices (e.g., EEPROMs, ROMs, PROMs, RAMs, SRAMs, etc.), hardware, electronic devices, a readable storage diskette, CD-ROM, a file server providing access to the programs via a network transmission line, wireless transmission media, signals propagating through space, radio waves, infrared signals, etc. Of course, those skilled in the art will recognize that many modifications may be made to this configuration without departing from the scope of the present invention.

The described implementations utilized a web-based environment utilizing the Hypertext Transfer Protocol (HTTP) for transmitting documents between computers within a network. However, those skilled in the art will appreciate that the preferred embodiments may apply to any communication protocol for allowing a terminal to request and access files in a network environment

In the described implementations, the pages utilized the Hypertext Markup Language (HTML) file format However, alternative file formats for building web-like pages may be used, such as Dynamic Hypertext Mark-Up Language (DHTML), the Extensible Markup Language (XML), Cascading Style Sheets, any other Standard Generalized Markup Language (SGML), or any other language known in the art for creating interchangeable, structured documents. Further, any version of HTML may be used, including version 2.0, 3.2, 4.0, etc. In yet further implementations, the requested file may be in any other file format, i.e., other than an SGML type format, capable of being displayed or otherwise executed by the requesting terminal.

The described implementations involved a network environment in which pages are provided to a terminal from a server over a network, such as the Internet. Additionally, the interlinking pages may be maintained within and used by a single computing device, such as a computer with a hard disk drive.

The described implementations used indexable pages including hyperlinks to provide information on QA documentation for a storage device. In alternative implementations, the described QA tool 4 may be used to provide documentation on any electronic device having multiple individually testable components, such as a printer, network, and any other computer or input/output (I/O) device known in the art.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for maintaining information in a computer readable medium on quality assurance procedures for testing a device, comprising:
displaying a main page including sections for different device components;
displaying a hyperlink in the main page to an overview page providing an overview of quality assurance operations to perform on the device; and
for each component listed on the main page, displaying a hyperlink in the main page to a component test page providing details on diagnostic tests to perform on the component listed on the main page.

2. The method of claim 1, further comprising:
for each component listed on the main page, displaying a hyperlink to a result page providing access to test result data generated when performing the diagnostic tests described in the component test page on the listed component.

3. The method of claim 1, wherein the component test page is comprised of a test case specification page providing information on the component and the diagnostic tests and a test procedure page providing information on steps to perform to implement the diagnostic tests for the component.

4. The method of claim 2, wherein the test result page includes hyperlinks to test result log files to which test result information is generated, wherein each test result page provides a different type of test result information.

5. The method of claim 1, further comprising:
providing a database including records for each component of the device to test, wherein each component record includes information on the overview page and component test page including information for the component; and
processing the database to generate the main page.

6. The method of claim 1, wherein the tested device comprises a storage device, wherein the tested components of the storage device include storage medium, an interface card, a controller, and power units.

7. A method for managing quality assurance procedures for testing a device, comprising:
for each quality assurance test procedure, collecting a test result;
for each collected test result, generating a hyperlinked code; and
displaying the hyperlinked codes categorized by the quality assurance test procedures on a page viewable by a web browser.

8. The method of claim 7, further comprising:
reviewing a database containing a plurality of test cases containing QA documents;
determining which of the plurality of test cases are applicable to a particular device; and
generating a test matrix containing links to access applicable QA documents and displaying the hyperlinked codes.

9. The method of claim 7, wherein the hyperlinked code is hyperlinked to a test log journal of the quality assurance test procedure represented by the hyperlinked code.

10. The method of claim 8, wherein the QA document comprises a test plan, test case specification or test procedures.

11. A system for maintaining information on quality assurance procedures for testing a device, comprising:
a processor;
a computer readable medium accessible to the processor, comprising:
(i) an overview page providing an overview of quality assurance operations to perform on the device;
(ii) a component test page providing details on diagnostic tests to perform on device components;
(iii) a main page including:
(a) information on a plurality of device components;
(b) a hyperlink to the overview page; and
(c) for each device component included on the main page, a hyperlink to one component test page providing details on diagnostic tests to perform on the device component; and
a program logic including code capable of causing the processor to display the main page, the hyperlinks on the main page, and the overview page and component test page in response to selection of the hyperlinks.

12. The system of claim 11, the computer readable medium further comprising:
a result page providing access to test result data generated when performing the diagnostic tests described in the component test page on the listed component
for each device component listed on the main page, a hyperlink to the result page.

13. The system of claim 11, wherein the component test page is comprised of a test case specification page providing information on the component and the diagnostic tests and a test procedure page providing information on steps to perform to implement the diagnostic tests for the component.

14. The system of claim 12, wherein the test result page includes hyperlinks to test result log files to which test result information is generated, wherein each test result page provides a different type of test result information.

15. The system of claim 11,
wherein the computer readable medium further includes a database including records for each component of the device to test, wherein each component record includes information on the overview page and component test page including information for the component; and
a means for processing the database to generate the main page.

16. The system of claim 11, wherein the tested device comprises a storage device, wherein the tested components of the storage device include a storage medium, an interface card, a controller, and power units.

17. A system for managing information on quality assurance procedures for testing a device, comprising:
a computer readable medium including a main page capable of being viewed by a browser program;
for each quality assurance test procedure, a means for collecting test results;
for each collected test result, a means for generating a hyperlink code in the main page; and
a means for displaying the hyperlinked codes in the main page categorized by the quality assurance test procedures.

18. The system of claim 17, further comprising:
a means for reviewing a database containing a plurality of test cases containing QA documents;
a means for determining which of the plurality of test cases are applicable to a particular device; and
a means for generating a test matrix containing links to access applicable QA documents and displaying the hyperlinked codes.

19. The system of claim 17, wherein the hyperlinked code is hyperlinked to a test log journal of the quality assurance test procedure represented by the hyperlinked code.

20. The system of claim 18, wherein the QA document comprises a test plan, test case specification or test procedures.

21. A program for maintaining information in a computer readable medium on quality assurance procedures for testing a device, comprising a computer usable media including at least one computer program embedded therein that is capable or causing at least one computer to perform:
displaying a main page including sections for different device components;
displaying a hyperlink in the main page to an overview page providing an overview of quality assurance operations to perform on the device; and
for each component listed on the main page, displaying a hyperlink in the main page to a component test page providing details on diagnostic tests to perform on the component listed on the main page.

22. The program of claim 21, further performing:
for each component listed on the main page, displaying a hyperlink to a result page providing access to test result data generated when performing the diagnostic tests described in the component test page on the listed component.

23. The program of claim 21, wherein the component test page is comprised of a test case specification page providing information on the component and the diagnostic tests and a test procedure page providing information on steps to perform to implement the diagnostic tests for the component.

24. The program of claim 22, wherein the test result page includes hyperlinks to test result log files to which test result information is generated, wherein each test result page provides a different type of test result information.

25. The program of claim 21, further performing:
providing a database including records for each component of the device to test, wherein each component record includes information on the overview page and component test page including information for the component; and
processing the database to generate the main page.

26. The program of claim 21, wherein the tested device comprises a storage device, wherein the tested components of the storage device include storage medium, an interface card, a controller, and power units.

27. A program for managing quality assurance procedures for testing a device, comprising a computer usable media including at least one computer program embedded therein that is capable or causing at least one computer to perform:
for each quality assurance test procedure, collecting a test result;
for each collected test result, generating a hyperlinked code; and
displaying the hyperlinked codes categorized by the quality assurance test procedures on a page viewable by a web browser.

28. The program of claim 27, further performing:
reviewing a database containing a plurality of test cases containing QA documents;
determining which of the plurality of test cases are applicable to a particular device; and
generating a test matrix containing links to access applicable QA documents and displaying the hyperlinked codes.

29. The program of claim 27, wherein the hyperlinked code is hyperlinked to a test log journal of the quality assurance test procedure represented by the hyperlinked code.

30. The program of claim 28, wherein the QA document comprises a test plan, test case specification or test procedures.

31. A computer readable medium including pages of information on quality assurance procedures for testing a device, wherein a viewer program executing on a computer
is capable of accessing the pages from the computer readable medium and rendering the information therein, wherein the pages comprise:
an overview page providing an overview of quality assurance operations to perform on the device;
a component test page providing details on diagnostic tests to perform on device components;
a main page including:
(i) information on a plurality of device components;
(ii) a hyperlink to the overview page; and
(iii) for each device component included on the main page, a hyperlink to one component test page providing details on diagnostic tests to perform on the device component.

32. The computer readable medium of claim 31, further comprising:
a result page providing access to test result data generated when performing the diagnostic tests described in the component test page on the listed device component.

33. The computer readable medium of claim 31, wherein the component test page is comprised of a test case specification page providing information on the component and the diagnostic tests and a test procedure page providing information on steps to perform to implement the diagnostic tests for the component.

34. The computer readable medium of claim 32, wherein the test result page includes hyperlinks to test result log files to which test result information is generated, wherein each test result page provides a different type of test result information.
